(19) United States
(12) Patent Application Publication
(10) Pub. No.: US 2013/0094239 A1
(43) Pub. Date: Apr. 18, 2013

(54) LIGHT GUIDE COLUMN, LIGHT EMITTING STRUCTURE AND ILLUMINATION DEVICE USING THE SAME

(71) Applicants: Liang-Hsiang Huang, New Taipei City (TW); Shih-Chin Chou, Kaohsiung City (TW); Sheng-Xing Duan, Hsinchu City (TW)

(72) Inventors: Liang-Hsiang Huang, New Taipei City (TW); Shih-Chin Chou, Kaohsiung City (TW); Sheng-Xing Duan, Hsinchu City (TW)

(73) Assignee: LEXTAR ELECTRONICS CORPORATION, Hsinchu (TW)

(21) Appl. No.: 13/535,186

(22) Filed: Jun. 27, 2012

Related U.S. Application Data
(60) Provisional application No. 61/547,784, filed on Oct. 17, 2011.

(51) Int. Cl. G02B 6/00

(52) U.S. Cl. 362/555; 362/551

(57) ABSTRACT

A light guide column is disposed on the top of a light source. The light guide column includes a column body, a cavity, a reflection structure and a micro-structure. The column body has a first end and a second end opposite to the first end. The cavity on the first end is for gathering the light source. The reflection structure is on the second end, when light emitted from the light source, a portion of the light reflected by the reflection structure to emit toward a lateral surface of the column body and others transmitted to the front side direction. The micro-structure is formed on the lateral surface of the column body can facilitate the emitting light from the column body uniformly.

This application claims the benefit of U.S. provisional application Ser. No. 61/547,784, filed Oct. 17, 2011, the subject matter of which is incorporated herein by reference.

### BACKGROUND OF THE INVENTION

1. Field of the Invention

The invention relates in general to a lamp structure, and more particularly to a light guide column, a light emitting structure and an illumination device using the same.

2. Description of the Related Art

In general, the LED light source, which provides illumination, can be used in various types of lamp structure, such as the light bulb or the tubular lamp. The light emitted by the LED light source is upwards from the cover of the light bulb or the tubular lamp to generate a light emitting field on the front side direction, but the light emitting angle is small than 180 degree. Compared with conventional incandenscent light source, the light emitting angle is 360 degree greater than that of LED light source.

In addition, the mura may occur to the lateral surface of the cover due to an uneven distribution of luminance. Consequently, the uniformity and illumination range of the light source are affected. Thus, the conventional lamp structure needs to be further improved in terms of light emitting angle or luminous uniformity.

### SUMMARY OF THE INVENTION

The invention is directed to a light guide column, a light emitting structure and an illumination device using the same for increasing the light emitting angle and resolving the problems arising due to the uneven distribution of luminance.

According to an aspect of the present invention, a light guide column is provided. The light guide column is disposed on top of a light source. The light guide column includes a column body, a cavity, a reflection structure and a micro-structure. The column body has a first end and a second end opposite to the first end. The cavity on the first end is for gathering light from the light source. The reflection structure is on the second end, when emitted light is transmitted through the column body to the reflected structure, a portion of light is reflected by the reflection structure toward the lateral surface of the column body and others transmitted to the front side direction. The micro-structure is formed on the lateral surface of the column body to facilitate the light emitting from the column body uniformly.

According to an alternative aspect of the present invention, a light emitting structure is provided. The light emitting structure includes a circuit board, at least one light source disposed on the circuit board and at least one light guide column disposed on the circuit board and on the top of the light source. The light guide column includes a column body, a cavity, a reflection structure and a micro-structure. The column body has a first end and a second end opposite to the first end. The cavity on the first end is for gathering light from the light source. The reflection structure is on the second end, when emitted light is transmitted through the column body to the reflection structure, a portion of the light is reflected by the reflection structure toward a lateral surface of the column body and others transmitted to the front side direction. The micro-structure is formed on the lateral surface of the column body to facilitate the light emitting from the column body uniformly.

According to an alternative aspect of the present invention, an illumination device is provided. The illumination device includes a holder, a circuit board disposed on the holder, at least one light source disposed on the circuit board, and at least one light guide column disposed on the circuit board and on the top of the light source. The light guide column includes a column body, a cavity, a reflection structure and a micro-structure. The column body has a first end and a second end opposite to the first end. The cavity on the first end is for gathering light from the light source. The reflection structure is on the second end, when emitted light is transmitted through the column body to the reflection structure, a portion of light is reflected by the reflection structure toward the lateral surface of the column body and others transmitted to the front side direction. The micro-structure is formed on the lateral surface of the column body to facilitate the light emitting from the column body uniformly.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-section schematic diagram of a light guide column according to an embodiment;

FIG. 2 shows a schematic diagram of a light emitting structure and an illumination device using a single light guide column according to an embodiment of the present invention;

FIGS. 3A and 3B show a schematic diagram of micro-structures according to an embodiment of the present invention;

FIG. 4A-4E show another schematic diagram of micro-structures according to an embodiment of the present invention;

FIG. 5 shows another schematic diagram of a light emitting structure and an illumination device using multiple light guide columns according to an embodiment of the present invention; and

FIG. 6 shows another cross-section schematic diagram of a light guide column according to an embodiment of the present invention.

FIGS. 7A and 7B show two diagrams of the light radiation fields of an illumination device with micro-structures on the light guide column according to an embodiment

### DETAILED DESCRIPTION OF THE INVENTION

According to the light guide column, the light emitting structure and the illumination device using the same in the present embodiment, a reflection structure is provided for changing the light emitting direction and enlarge the light emitting field. A micro-structure is also provided for the uniformity of light emitting field on the lateral surface, so that the light generated by the high-directional light source (such as a LED) can be guided by the column body, reflected by the reflection structure and diffracted by the micro-structure so as to form a light emitting field with omni-directional angle. In addition, the micro-structure is formed on the lateral surface of the column body with notches to smooth the light emitting field and resolve the uneven distribution of luminance.

Various embodiments are disclosed below for detailed descriptions of the invention. However, these embodiments are for exemplification only, not for limiting the scope of protection of the invention.

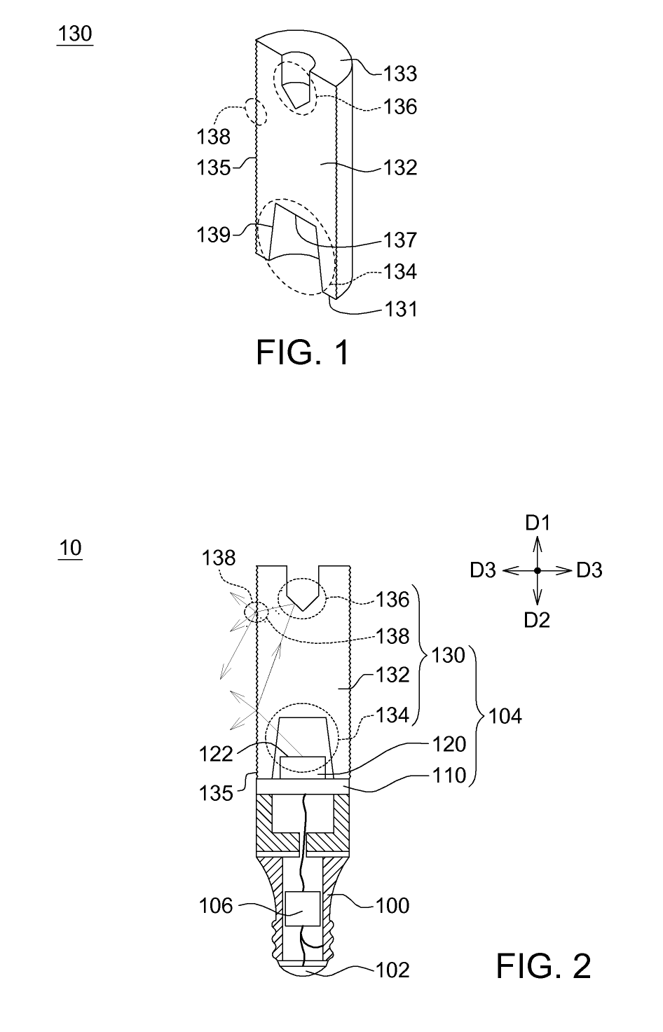

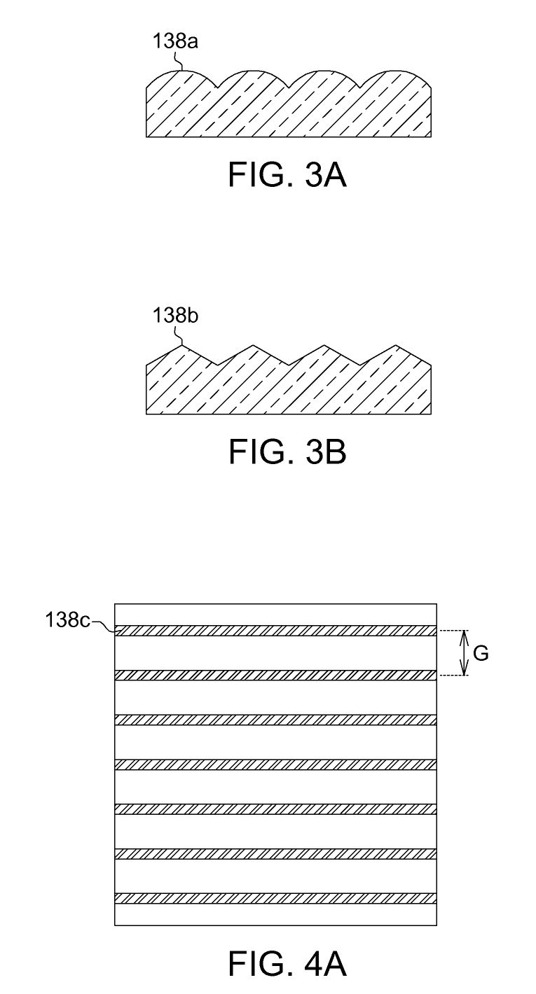

Referring to FIGS. 1 and 2. FIG. 1 shows a cross-section schematic diagram of a light guide column according to an embodiment of the present invention. FIG. 2 shows a schematic diagram of a light emitting structure and an illumination device using a single light guide column according to an embodiment of the present invention. The illumination device 10 includes a holder 100, an electrical connecting head 102 and a light emitting structure 104. The holder 100 has a receiving space for disposing a drive circuit module 106. The electrical connecting head 102 is disposed below the holder 100 for receiving an external power. The holder 100 is made of metal (such as copper or aluminum) or electric-insulating thermal-conduction material (such as plastic or ceramics). In the present embodiment, the drive circuit module 106 can provide variable voltage and AC to DC (or DC to DC) conversion, and the circuit board 110 is connected to the electrical connecting head 102 through the drive circuit module 106 to form a conduction circuit. Thus, the light source 120 can receive the external power via the electrical connecting head 102 to provide illumination for the illumination device 10.

The light emitting structure 104 includes a circuit board 110, a light source 120 and a light guide column 130. The light guide column 130 is disposed on the circuit board 110 and on top of the light source 120. The light guide column 130 includes a column body 132, a cavity 134, a reflection structure 136 and a micro-structure 138. The column body 132 is a transparent light guide body, which is disposed on the light emitting direction (i.e. the front side direction D1) of the light source 120. The column body 132 has a first end 131 and a second end 133. The first end 131 is opposite to the second end 133. The cavity 134 on the first end 131 for receiving the light source 120. The cavity 134 is indented inward from the first end 131 to be a cup structure, which has a bottom surface 137 on top of the light source 120 and opposite to a light emitting surface 122 of the light source 120. In the present embodiment, the bottom surface 137 of the cavity 134 is a plane, and the angle of the slanted surface 139 connected to the bottom surface 137 can be adjusted to introduce the light B into the light guide column 130 to enhance the brightness of the light emitting structure 104 effectively.

The light source 120, for example, is a light emitting diode disposed in the cavity 134. The light B emitted from the light source 120 enters into the column body 132 through the cavity 134 and is reflected to reach the reflection structure 136 on the second end 133. The reflection structure 136 is indented inward from the second end 133 to be a concave structure. In the present embodiment, the reflection structure 136 has a V-shaped slot, and a portion of the light B can be reflected by the reflection structure 136 so as to emit from the lateral surface 135 of the column body 132 or emit toward a back side direction D2 opposite to the light emitting direction (i.e. the front side direction D1) of the light source 120, and thereby the light emitting angle is increased.

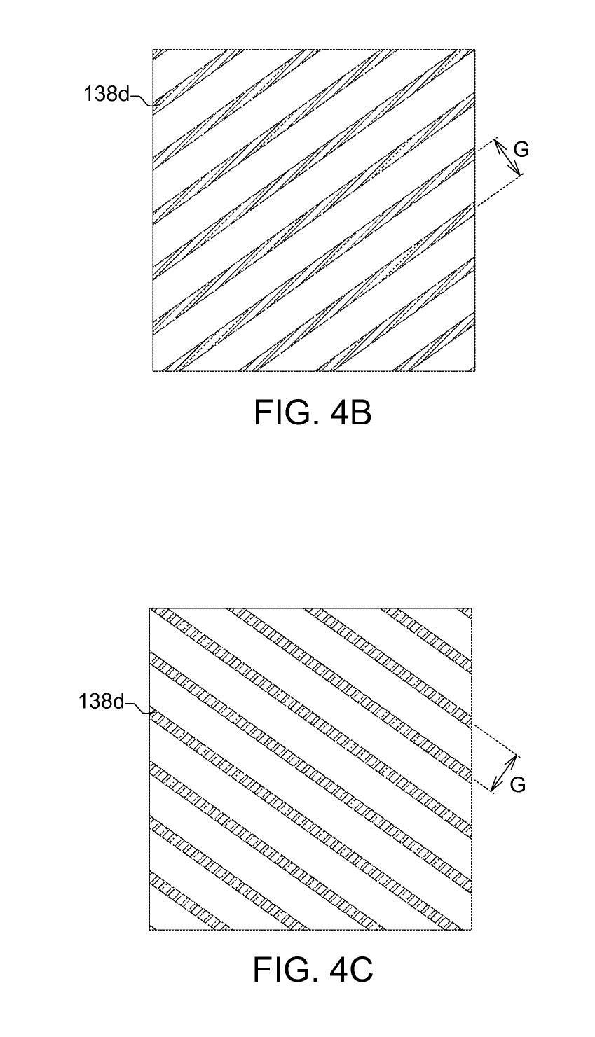

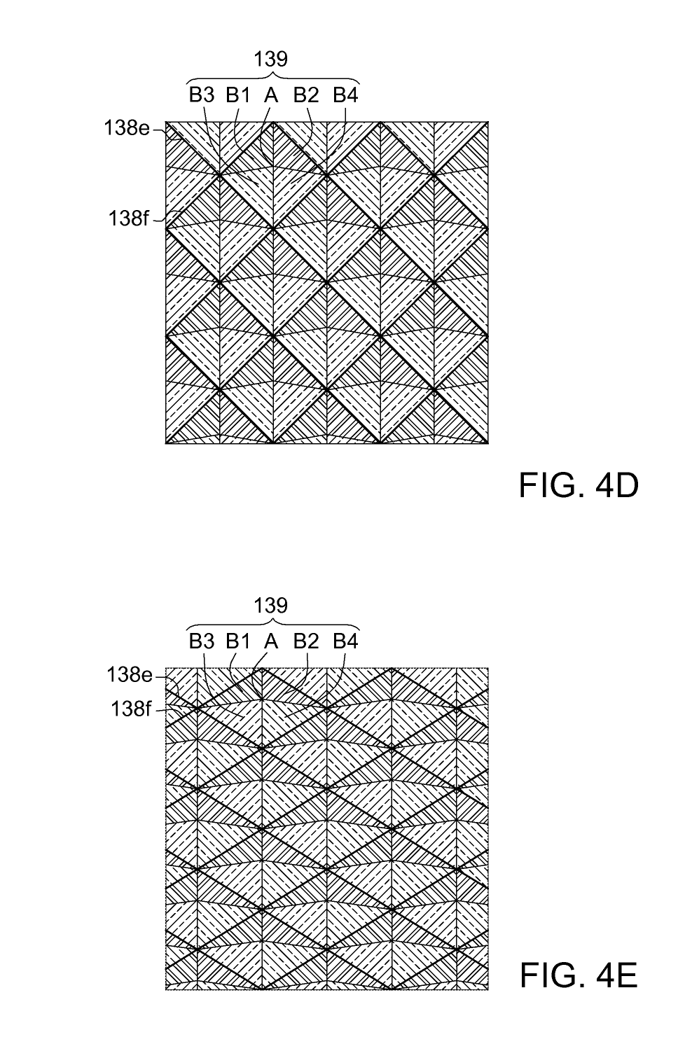

The micro-structure 138 on the lateral surface 135 of the column body 132 is used to refract the light B to facilitate the light B emitting from the column body 132 uniformly. Please refer to the FIGS. 3A and 3B, which show a cross-section diagram of the micro-structure 138 according to an embodiment of the present invention. In the FIG. 3A, the micro-structure 138 is composed of a plurality of semi-round structures 138a. In the FIG. 3B, the micro-structure 138 is composed of a plurality of polygon structures 139a, such as a pyramid, a triangular pyramid, a cone, and no specific restriction is applied in the invention. In addition, please refer to FIGS. 4A-4E, which show schematic diagrams of the micro-structure 138 having different notch patterns according to an embodiment of the present invention. The notch pattern in the FIG. 4A includes a plurality of stripe notches 138c arranged in parallel. The notch pattern in the FIGS. 4B and 4C includes a plurality of oblique notches 138d (slanted to right or left) arranged in parallel. The gap between two neighboring stripe notches is about 0.1˜1 μm, and preferably 03˜0.4 μm. The notch pattern in the FIGS. 4D and 4E includes a plurality of notches 138e and 138f interlaced to each other to form a plurality of pyramids 139, and each pyramid 139 has an apex A and four triangular surfaces B1-B4. The triangular surfaces B1-B4 are refraction surfaces toward different sides so that the light can be refracted to different directions. In the present embodiment, the micro-structure 138 having different notch patterns is used to control the light emitting fields on the lateral surface direction D3 and the back side direction D2 to form a light emitting field with omni-directional angle (360 degree).

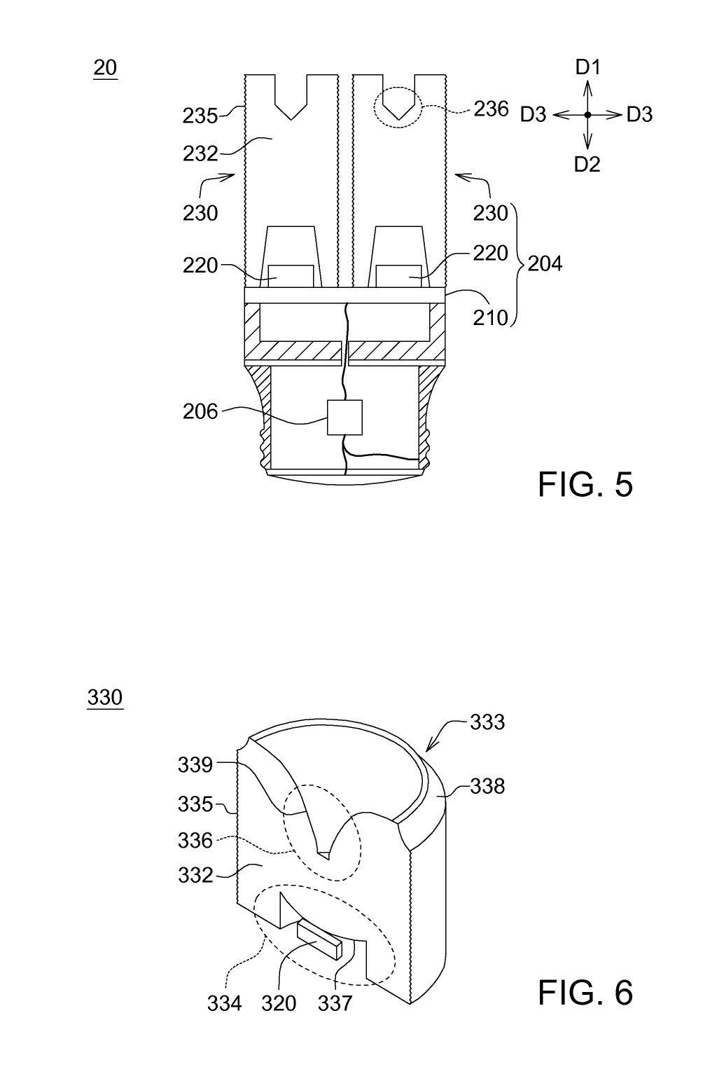

Referring to FIG. 5, a schematic diagram of a light emitting structure 204 and an illumination device 20 using multiple light guide columns 230 according to an embodiment of the present invention is shown. The difference between the present embodiment and the first embodiment is that the light emitting structure 204 and the illumination device 20 includes multiple light guide columns 230 and multiple light sources 220. Each of the light guide columns 230 is disposed on the circuit board 210 and on top of the light sources 220 respectively to change the light emitting angle of each light source 120. The drive circuit module 206 is connected to each of the light sources 220 through the circuit board 210 to control the light sources 220 individually or simultaneously. The light sources 220, for example, are light emitting diodes, and a portion of light B can be reflected by the reflection structure 236 so as to emit from the lateral surface 235 of the column body 232 or emit toward a back side direction D2 opposite to the light emitting direction (i.e. the front side direction D1) of the light sources 220, and thereby the light emitting angle is changed. Thus, the light emitting fields on the front side direction D1, the lateral surface direction D3 and the back side direction D2 can be controlled by the light guide columns 230 of the present embodiment to form a light emitting field with omni-directional angle (360 degree).

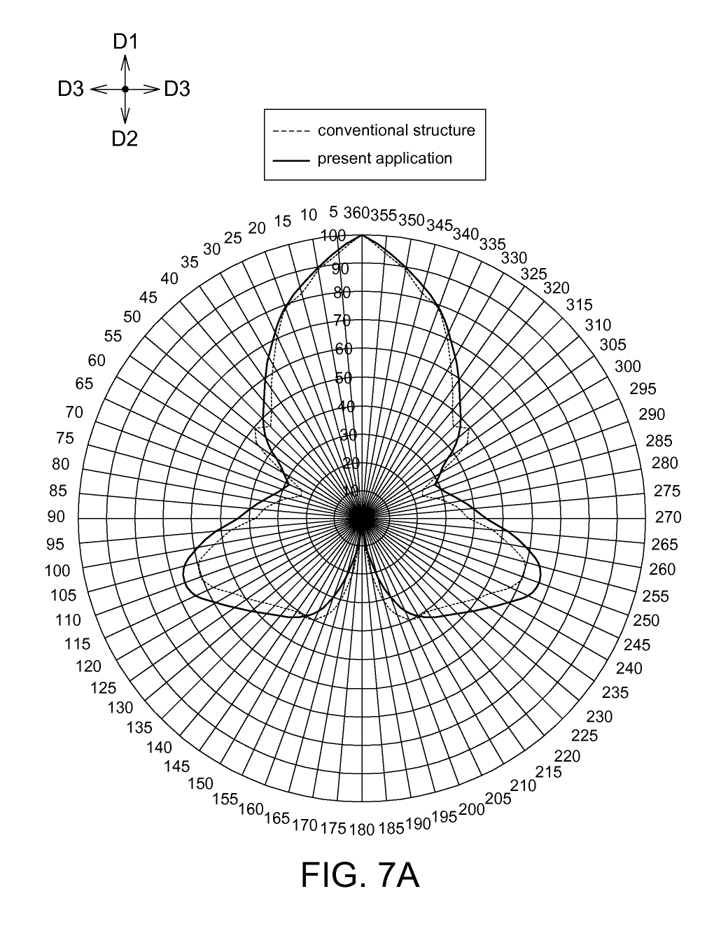

Referring to FIG. 6, a cross-section schematic diagram of a light guide column 330 and a light source 320 according to an embodiment of the present invention is shown. The difference between the present embodiment and the first embodiment is that the bottom surface 337 of the cavity 334 is a curved surface. The curvature of the bottom surface 337 can be adjusted to introduce the light into the light guide column 330 to enhance the brightness of the light emitting structure effectively. In addition, the slot of the reflection structure 336 is shaped as a horn whose inner side 339 is a curved surface contracted gradually, and the reflection structure 336 has a bottom surface, which is a plane for example. In the present embodiment, the size of the slot of the reflection structure 336 can be adjusted to control the light emitting field on the front side direction D1. In addition, the outer peripheral surface 338 at the second end 333 of the column body 332 is a concave surface, and a portion of light can be reflected by the reflection structure 336 and the outer peripheral surface 338 so as to emit from the lateral surface 335 of the column body 332 and/or emit toward a back side direction D2, and thereby the light emitting angle is increased.

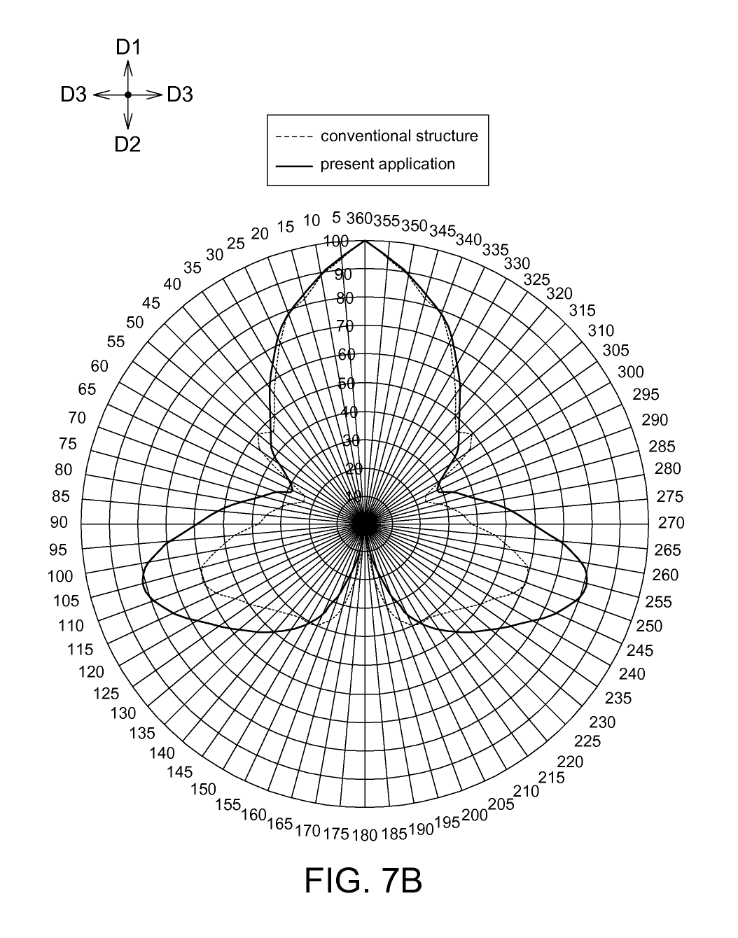

Referring to FIGS. 7A and 7B, which show two diagrams of the light radiation fields of an illumination device with micro-structures on the light guide column according to an embodiment, respectively. As indicated in the results of measurement, in comparison to the conventional light guide column without micro-structures, the light emitting intensity on the lateral direction D3 of the column body of the present embodiment in FIG. 7A is increased from 60% to 70% when the gap between two neighboring stripe notches is about 0.4 mm. In addition, the light emitting intensity on the lateral direction D3 of the column body of the present embodiment in FIG. 7B is increased from 60% to 80% when the gap between two neighboring stripe notches is about 0.4 mm. Thus, the light emitting filed of the illumination device of the present embodiment between the lateral direction D3 and the back side direction D2 are increased, instead of concentrating right above the light guide column. Since the light emitting angle of the column body is increased in the lateral direction D3, mura or hot spots arising from an uneven distribution of luminance are not seen on the lateral surfaces.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guide column, disposed on the top of a light source, the light guide column comprising:
a column body having a first end and a second end opposite to the first end, the column body is axially extending;
a cavity on the first end for gathering the light source;
a reflection structure on the second end, when emitted light from the light source is transmitted through the column body to the reflection structure, a portion of the light reflected by the reflection structure to emit toward the lateral surface of the column body and others transmitted to the front side direction; and
a micro-structure being on the lateral surface of the column body can facilitate the emitting light from the column body uniformly.

2. The light guide column according to claim 1, wherein the cavity is a cup structure.

3. The light guide column according to claim 1, wherein the reflection structure is a concave structure.

4. The light guide column according to claim 2, wherein the cup structure has a bottom surface facing a light emitting surface of the light source.

5. The light guide column according to claim 1, wherein the micro-structure comprises a plurality of polygon structures or semi-round structures.

6. The light guide column according to claim 1, wherein the micro-structure has a plurality of notches, which include stripe notches or oblique notches arranged in parallel at an angle or two set of stripe notches interlaced to each other.

7. The light guide column according to claim 1, wherein the light source is a light emitting diode.

8. A light emitting structure, comprising:
a circuit board;
at least one light source, disposed on the circuit board;
at least one light guide column, disposed on the circuit board and on the top of the light source, wherein the light guide column comprises:
a column body having a first end and a second end opposite to the first end, the column body is axially extending;
a cavity on the first end for gathering the light source;
a reflection structure on the second end, when light emitted from the light source is transmitted through the column body to the reflection structure, a portion of the light is reflected by the reflection structure to emit toward the lateral surface of the column body and others transmitted to the front side direction; and
a micro-structure being on the lateral surface of the column body can facilitate the emitting light from the column body uniformly.

9. The light emitting structure according to claim 8, wherein the cavity is a cup structure.

10. The light emitting structure according to claim 8, wherein the reflection structure is a concave structure whose bottom surface is a plane, and an outer peripheral surface at the second end of the column body is a concave surface.

11. The light emitting structure according to claim 9, wherein the cup structure has a bottom surface facing a light emitting surface of the light source.

12. The light emitting structure according to claim 8, wherein the micro-structure comprises a plurality of polygon structures or semi-round structures.

13. The light emitting structure according to claim 8, wherein the micro-structure has a plurality of notches, which include strip notches or oblique notches arranged in parallel at an angle or two set of stripe notches interlaced to each other.

14. The light emitting structure according to claim 8, wherein the light source is a light emitting diode.

15. An illumination device, comprising:
a holder;
a circuit board, disposed on the holder;
at least one light source, disposed on the circuit board; and
at least one light guide column, disposed on the circuit board and on top of the light source, wherein the light guide column comprises:
a column body having a first end and a second end opposite to the first end;
a cavity on the first end for gathering the light source;
a reflection structure on the second end, when light emitted from the light source is transmitted through the column body to the reflection structure, a portion of light is reflected by the reflection structure to emit toward the lateral surface of the column body and others transmitted to the front side direction; and
a micro-structure being on the lateral surface of the column body can facilitate the emitting light from the column body uniformly.

16. The illumination device according to claim 15, wherein the holder has a receiving space for disposing a drive circuit module, and an electrical connecting head is disposed below the holder.

17. The illumination device according to claim 15, wherein the holder is made of metal or insulating thermal-conduction material.

18. The illumination device according to claim 15, wherein the cavity is a cup structure.

19. The illumination device according to claim 15, wherein the reflection structure is a concave structure whose bottom surface is a plane, and an outer peripheral surface at the second end of the column body is a concave surface.

20. The illumination device according to claim 18, wherein the cup structure has a bottom surface facing a light emitting surface of the light source.

21. The illumination device according to claim 15, wherein the micro-structure comprises a plurality of polygon structures or semi-round structures.

22. The illumination device according to claim 15, wherein the micro-structure has a plurality of notches, which include stripe notches or oblique notches arranged in parallel at an angle or two set of stripe notches interlaced to each other.
